(19) United States
(12) Patent Application Publication
(10) Pub. No.: US 2004/0188542 A1
(43) Pub. Date: Sep. 30, 2004

(54) Water misting and cooling system for a marinecraft

(76) Inventor: Pavlik Seann, Ft. Lauderdale, FL (US)

Correspondence Address: NIXON & VANDERHYE, PC, 1100 N GLEBE ROAD, 8TH FLOOR, ARLINGTON, VA, 22201-4714, US

(21) Appl. No.: 10/396,798

(22) Filed: Mar. 26, 2003

(51) Int. Cl. B05B 15/00

(52) U.S. Cl. 239/289

(57) ABSTRACT

A misting and cooling system is adapted for use in a marinecraft in which there is included a tubular framework closely associated with open areas of the craft. The tubular framework is provided with mist nozzles for dispensing pressurized micron-sized water vapor over open areas within the craft. Input tubing to the tubular framework is connected from a pressurized water source to provide water at pressures in a range of 200 to 1000 psi. At such pressures and fine dimension of droplet emission from high pressure nozzles, flash evaporation of atomized droplets occur, producing a cooling of the ambient atmosphere by as much as 30 degrees F. (16 degrees C.) substantially instantly. A considerable number of misting nozzles are provided in the tubular framework to cool occupants within a number of misting zones within the marinecraft.

### BACKGROUND OF THE INVENTION

A. Area of Invention

The invention relates to a mist cooling system particularly adapted for use with fishing, leisure and other marinecraft.

B. Prior Art

The use of water misting as cooling means in connection with a marine vessel is taught in U.S. Pat. No. 6,175,969 (2001) to Edwards, entitled Boat-Supported Water Misting and Cooling Apparatus. The invention of Edwards, while having certain objectives in common to the instant invention, lacks the same capability and effectiveness of the invention set forth herein by reason of its use of less than about ten percent of the fluid pressure, as well as a different nozzle type and size of orifice and resultant droplets, which renders the system as a whole far less effective.

In non-marine applications a number of devices are known which discharge a finely atomized water-mist over a given area for purposes of cooling. One example thereof appears in U.S. Pat. No. 478,791 to Sprung which relates to a greenhouse structure.

Such systems have also gained popularity in extremely arid parts of the country, such as Arizona, for use in outdoor waiting areas, such as bus stops. For example, this type of system appears in U.S. Pat. No. 5,598,719 (1997) to Jones, et. al., entitled Evaporative Cooling Apparatus. Moreover, systems such as Jones and Strung rely, for fluid input, upon a supply of water of typically 40 to 60 psi using a pump or pressure booster in order to increase fluid pressure.

The prior art, as reflected in the above, reflects a need for a system capable of dispensing high pressure atomized droplets capable of flash evaporating on contact with the air to, in accordance with the laws of thermodynamics, thereby produce an immediate and more effective cooling of the area of interest upon the marine craft. It is known that vaporized water will evaporate more quickly than other forms of water. However, in the use of high-pressure droplets upon a marine craft to cause flash evaporation and, thereby, release of the 600 calories of latent heat per gram of such water is not known in the art.

Accordingly, the invention seeks to improve upon known methods of use of water misting within a marine environment.

### SUMMARY OF THE INVENTION

This invention is directed to a misting and cooling system adapted for use in a marinecraft in which there is included a tubular framework closely associated with open areas of the craft. Said tubular framework is provided with a plurality of mist nozzles for dispensing pressurized finely atomized water over open areas within the marine craft. Input tubing to said tubular framework is connected from a pressurized water source which provides water at pressures in a range of 200 to 1000 psi. At such pressures micron sized droplets are ejected by the high pressure nozzles, causing flash evaporation of the droplets thereby cooling the ambient atmosphere by as much as 30 degrees F. (16 degrees C.) substantially instantly. A considerable number of misting nozzles from associated framework tubing are provided to cool occupants within a number of misting zones within the marinecraft.

It is thus an object of the invention to provide a system for distribution of atomized particles of water vapor into open areas of boats thereby to cool occupants by flash evaporation of such droplets.

It is another object to provide to apparatus of the above type by which occupants made be quickly cooled without any substantial wetting of the skin or surfaces of the boat or thereabout.

It is further object of the invention to provide a system of the above type which may be readily installed into the marinecraft.

It is a yet further object to provide a misting system of the above type which utilizes a fresh water source of the craft for pressurizing of water employed by the system.

The above and yet other objects of the invention, the below, will become apparent from the hereinafter set forth Brief Description of the Drawings, Detailed Description of the Invention, and Claims appended herewith.

### BRIEF DESCRIPTION OF THE DRAWINGS

FIG. 1 is a side elevation view of a boat of a type with which the invention may be employed, showing therein, a fluid reservoir and pump assembly associated therewith.

FIG. 1A is an enlarged view of a tuna tower of the boat of FIG. 1.

FIG. 2 is a rear perspective view of an area of the vessel of FIG. 1, beneath an awning thereof, showing the emission of mist from a tubular structural member of the awning furnished with appropriate misting nozzles.

FIG. 3 is an enlarged view of the fore portion of the vessel of FIG. 1 showing the emission of water vapor misting from tubular structures and the supply of pressurized water to the nozzles thereof.

FIG. 4 is an enlarged view showing the area of connection between a water supply line using the instant invention and tubular framework to which pressurized water is thereby supplied.

FIG. 5 is an enlarged view of a portion of FIG. 2 showing the integration of functional tubular members on the nozzles thereof, as well showing the connection of FIG. 4 above to the source of pressurized water.

FIG. 6 is a radial cross-sectional view taken along Line 6-6 FIG. 5.

FIG. 7 is a side elevation view showing the application of the present invention to a larger yacht or cruise ship.

FIG. 8 is an enlarged portion of the aft area of the vessel of FIG. 7 showing the use of the present misting system at multiple levels thereof.

### DETAILED DESCRIPTION OF THE INVENTION

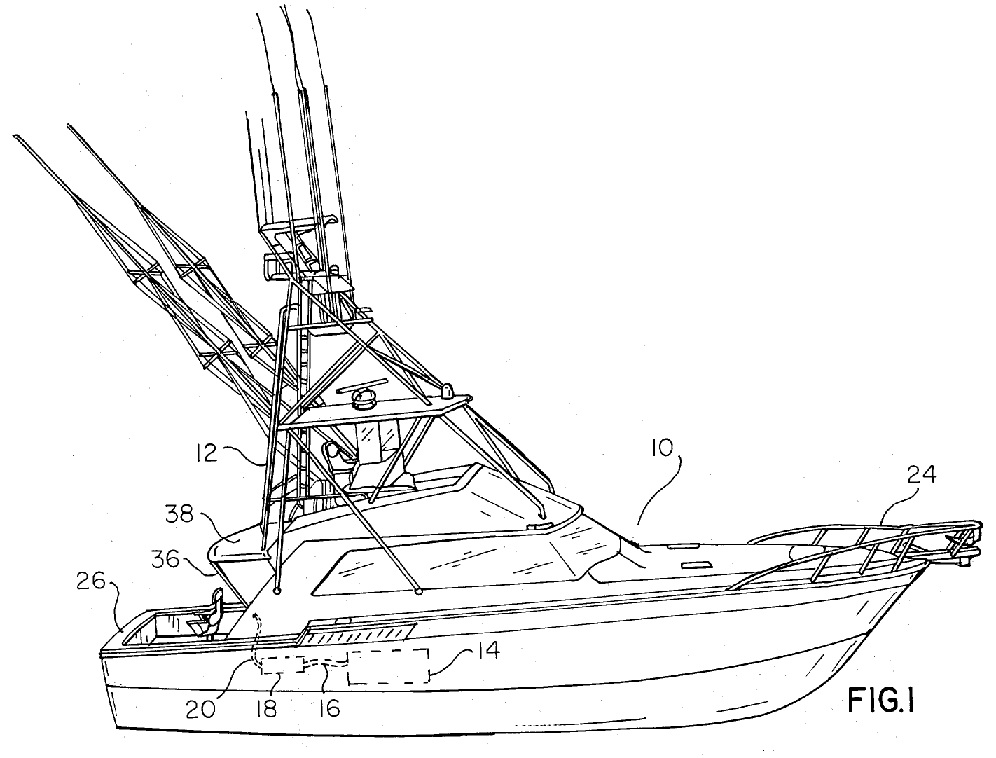

With reference to the elevational view of FIG. 1, there is shown a fishing yacht 10 which, typically, will include a tuna tower 12 which is a common feature upon such boats. See FIG. 1A.

Shown in phantom at the bottom center of FIG. 1 is a reservoir 14 of water which, through conduit 16, is in fluid communication with a pump/compressor 18 having a maximum discharge pressure as high as 1500 psi although an applicable range of outputs thereof for purposes of the present invention, is between 200 and 1000 psi. A suitable pump/compressor for the present application has been found to be a Triplex Direct Drive Plunger Pump Module 2SF, which is sold by Cat Pumps, Minneapolis, Minn. 55449.

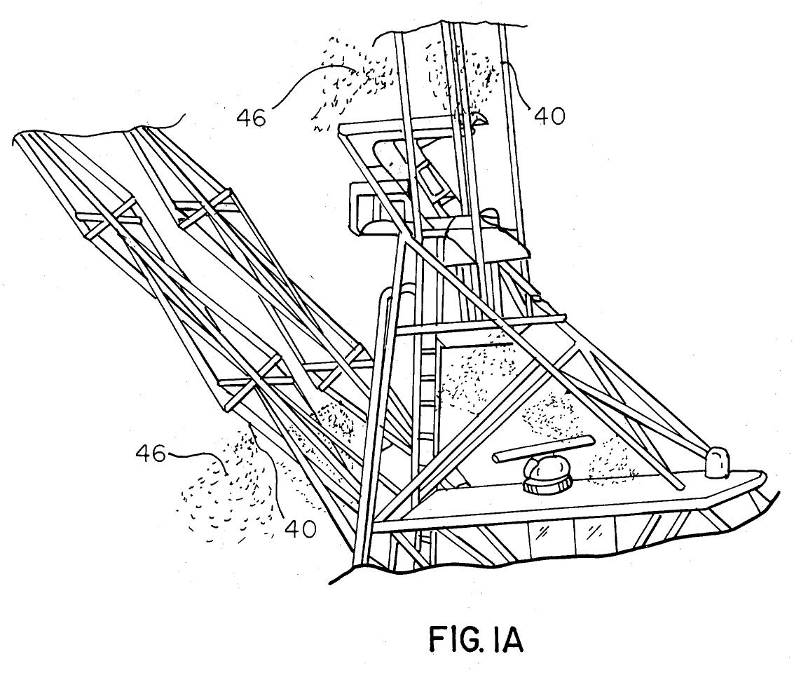

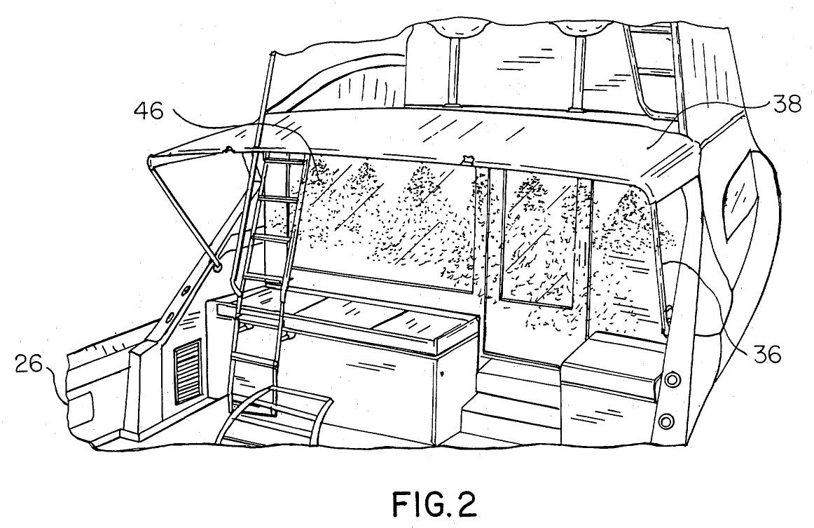

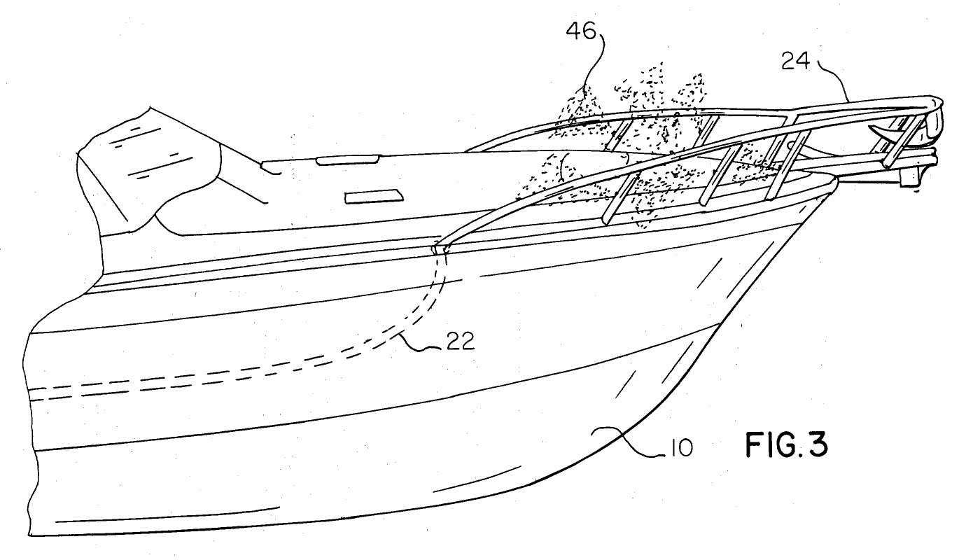

As may be further noted in FIG. 1, one or more pressurized output conduits 20 and 22 are provided from pump 18, this to the front or fore portion 24 of the boat as well as to the aft area 26 thereof. In a fishing yacht of the type shown in FIG. 1, the atomized spray of the instant invention is typically provided to both the primary fishing area in the aft area 26 (see FIG. 2) and, secondarily, to the front portion 24, shown in FIG. 3.

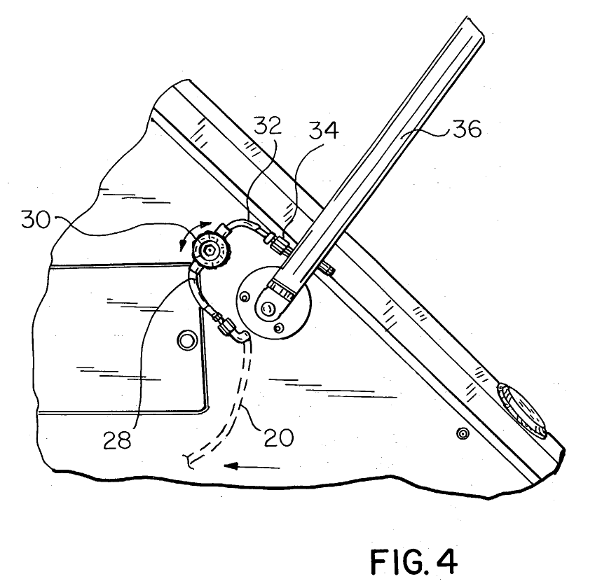

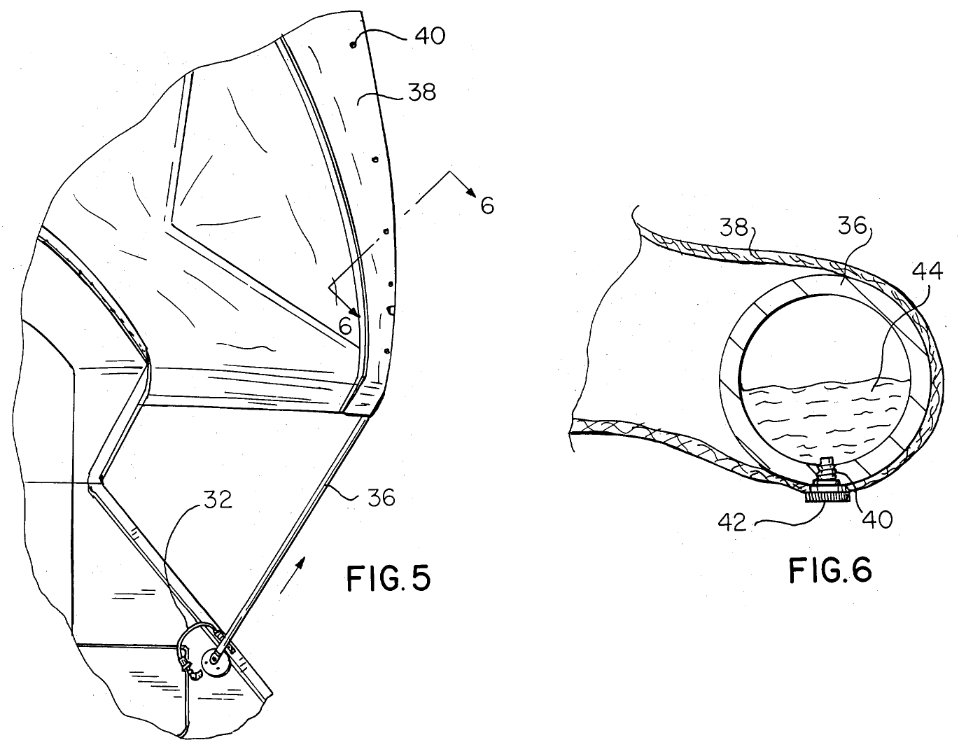

More particularly, as is shown in FIG. 4, the pressurized outlet conduit 20 is provided to piping 28 and, therefrom, to an unloader valve 30 associated with pump 18 and a flow gauge, by which the volumetric flow of the water into a conduit 32 may be controlled. Therefrom, flange 34 provides a fluid communication from conduit 32 to tubular framework 36 upon which awning 38 (see FIGS. 2 and 5) is held, and framework 40 of tuna tower 12. See FIG. 1A. Within said tubular framework is provided a plurality of apertures 40 into which is placed misting nozzles 42 (see FIG. 6). As may be noted therefrom, water 44 is maintained within tubular framework 36 under as much as 1000 psi which, upon actuation of said valve 30, is forced through orifices about 0.2 to 0.5 mm. The combination of high pressure and small orifice size produces and dispenses droplets as small as 5 microns. It has been found that when water droplets of such small dimension are ejected at high pressure into ambient air of 80 to 110 degrees F., they will flash evaporate thereby causing instant release of their latent heat of about 600 calories per gram. Thereby, a rapid evaporative cooling occurs in the area of the misting which, typically, is within 6 to 10 feet of the nozzle itself. Misting 46 under awning 38 is shown in FIG. 2. Misting nozzles 42 are sold by Fogco System, Ltd., Newcastle-on-Tyne, UK.

In FIG. 3 is shown misting at the fore portion 24 of the yacht where it may be employed to cool that portion of the boat, whether or not passengers are in that area, thereby reducing the overall temperature of that portion of the craft which, typically, will be the living quarters of the boat. It has been found that flash evaporation of extremely fine droplets of water of the type described above will cause a drop in temperature of surrounding air of as much as 30 degrees F. (16 degrees C.) in a matter of seconds. Such a region 46 of cooled air produces a refreshing effect to thereby minimize the detrimental effects of hot sun on outdoor activities upon boats, including fishing yachts.

Optimum conditions for evaporative cooling exist when the ambient humidity is below eighty percent. However, it has been found that by chilling or refrigerating the water within tank 14 (see FIG. 1), a significant degree of cooling by the present system can be accomplished even at higher humidities.

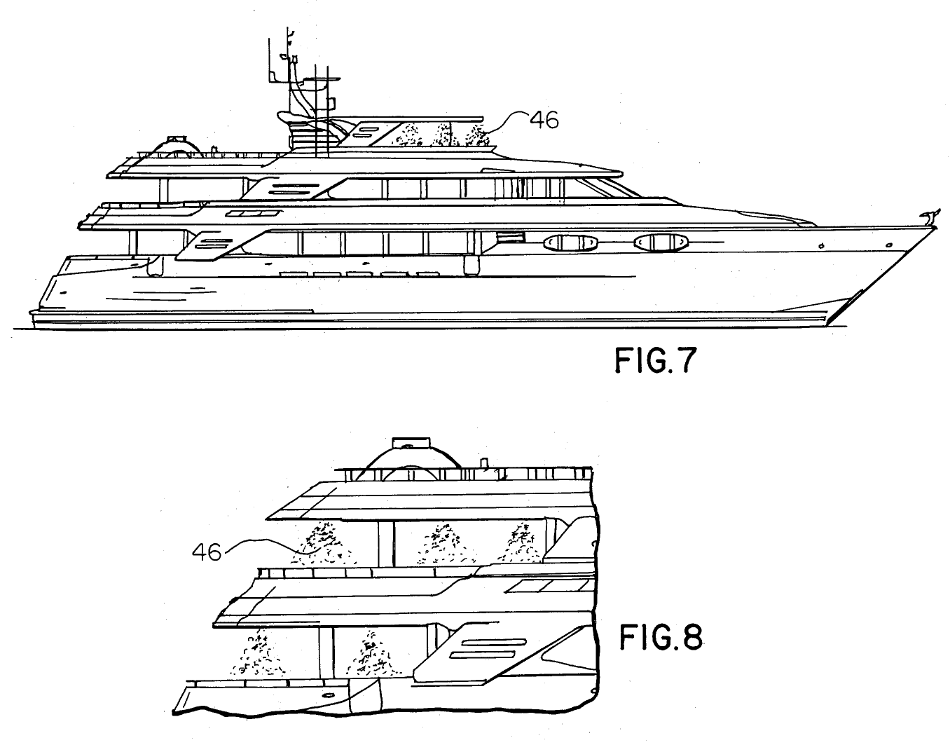

With reference to FIGS. 6 and 7, an adaptation of the above-set forth principles to larger yacht and cruise ships is seen. Thereon, the instant system, operating off of a single reservoir in the hold of the boat and a single pump, may provide sufficient pressure and water to provide evaporative cooling in accordance with the present invention to all levels of the craft.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

I claim:

1. A method of misting and cooling selectable zones of a marinecraft, the method comprising the steps of:
(a) In a tubular framework associated with open areas of said marinecraft occupied by passengers, inserting a plurality of misting nozzles within segments of said framework corresponding to zones in which cooling thereof is desired, said nozzles each having apertures sufficient to produce outputs of micron-size droplets of water vapor; and
(b) selectively providing fresh water pressurized to between about 200 and about 1000 psi, as an input to said tubular framework,
whereby high pressure ejection of said droplets from said apertures of said nozzles produce flash evaporation within the ambient atmosphere to produce cooling of as much as 30° F. (16° C.) in zones misted by outputs of said nozzles.

2. The method as recited in claim 1, further comprising the step of:
providing said apertures of said nozzles with orifices in a range about 0.2 to about 0.5 mm.

3. The method as recited in claim 2, further comprising the step of:
providing an atomized droplet output of said nozzles in a range of about 5 to about 100 microns.

4. The method as recited in claim 3 in which said fresh water source comprises a source of drinking water of the marinecraft.

5. The method recited in claim 3 in which said pressurized fresh water is provided by a high pressure pump fluidly interposed between said water source and said tubular framework.

6. A system of misting and cooling selectable zones of marinecraft, comprising:
(a) a tubular framework associated with open areas of said marinecraft, segments of said framework comprising nozzles having apertures sufficient to produce outputs of micron-size droplets of water vapor;
(b) a source of fresh water pressurized between about 200 and about 1000 psi; and
(c) means for selectably providing an output of said pressurized water to said tubular framework,
whereby high pressure ejection of said droplets from said apertures of said nozzles produce flash evaporation within the ambient atmosphere to produce cooling of as much as 30° F. (16° C.) in zones misted by outputs of said nozzles.

7. The system as recited in claim 6 in which said apertures of said nozzles comprise at least on aperture in a range of about 0.2 to about 0.5 mm.

8. The system as recited in claim 7 in which outputs of the apertures comprise droplets in a range of about 5 to about 100 microns.
